(19) United States
(12) Patent Application Publication
(10) Pub. No.: US 2019/0016608 A1
(43) Pub. Date: Jan. 17, 2019

(54) WATER PURIFIER, CONTROL METHOD THEREOF, AND DEVICE

(71) Applicants: Xiaoping CHEN, Foshan (CN); Foshan Viomi Electrical Technology Co., Ltd., Foshan (CN); Xiaomi Inc., Beijing (CN)

(72) Inventors: Xiaoping CHEN, Foshan (CN); Xinyu LIU, Beijing (CN)

(73) Assignees: Foshan Viomi Electrical Technology Co., Ltd., Foshan (CN); Xiaomi Inc., Beijing (CN); Xiaoping CHEN, Foshan (CN)

(21) Appl. No.: 16/133,559

(22) Filed: Sep. 17, 2018

Related U.S. Application Data
(63) Continuation of application No. PCT/CN2017/076058, filed on Mar. 9, 2017.

(30) Foreign Application Priority Data
Mar. 17, 2017 (CN) 201610158555.8

(51) Int. Cl. C02F 1/00; B01D 37/04

(52) U.S. Cl. CPC C02F 1/003; B01D 37/046; C02F 2101/20; C02F 2209/03; C02F 2209/40; B01D 37/043

(57) ABSTRACT

A water purifier, a method, and a device for controlling the water purifier are provided. The water purifier may include: a filter device including an input end for water to be purified connected with a source of water to be purified, and an output end for purified water connected with a faucet; a water flow detection device for detecting water flow condition in the filter device; a control device electrically connected to the water flow detection device and a power assembly of the filter device. When there exists a requirement on water purification from a user, the control device the control device sends a corresponding state control instruction to the power assembly based on whether the water flow condition satisfies a pre-defined water supply condition. The state control instruction controls whether to switch a working state of the filter device.

### CROSS-REFERENCE TO RELATED APPLICATIONS

This application is a continuation of International Application No. PCT/CN2017/076058, filed on Mar. 9, 2017, which is based on and claims priority to Chinese Patent Application No. 201610158555.8, filed on Mar. 17, 2016, the entire contents thereof are incorporated herein by reference.

### TECHNICAL FIELD

The present disclosure relates to the technical field of water purifiers, in particular to a water purifier and a method, a device for controlling the same.

### BACKGROUND

A water purifier, which is also called as water cleaner, may be used to remove floating objects, heavy metals, germs and the like. Therefore, it can not only remove off-flavor caused from such as rusts and bleaching powders, but ensure water quality safety which makes water to be safe for drinking directly.

### SUMMARY

According to a first aspect of the present disclosure, there is provided a water purifier including: a filter device in which an input end for water to be purified (hereinafter referred to as “input end”) of the filter device is connected with a source of water to be purified (hereinafter referred to as “water source”), and in which an output end for purified water (hereinafter referred to as “output end”) is connected with a faucet; a water flow detection device for detecting water flow condition in the filter device; a control device electrically connected to the water flow detection device and a power assembly of the filter device, in which, when there exists a requirement on water purification from a user, the control device sends a corresponding state control instruction to the power assembly based on whether the water flow condition satisfies a pre-defined water supply condition, the state control instruction controls whether to switch a working state of the filter device.

According to a second aspect of the present disclosure, there is provided a method for controlling a water purifier, in which an input end of the filter device of the water purifier is connected with a water source, and in which an output end is connected with a faucet; the method may include: determining water flow condition in the filter device; switching a working state of the filter device based on a situation that whether the water flow condition satisfies a pre-defined water supply condition when there exists a requirement on water purification from a user.

According to a third aspect of the present disclosure, there is provided a control device of a water purifier, in which an input end of the filter device of the water purifier is connected with a water source, and in which an output end is connected with a faucet; the device may include: a determination circuit for determining water flow condition in the filter device; a switch circuit for switching a working state of the filter device based on a situation that whether the water flow condition satisfies a pre-defined water supply condition when there exists a requirement on water purification from a user.

According to a fourth aspect of the present disclosure, there is provided a water purifier, in which an input end of the filter device of the water purifier is connected with a water source, an output end is connected with a faucet; the water purifier may include: a processor; a memory for storing a processor-executable instruction. The processor may be configured for: determining water flow condition in the filter device; switching a working state of the filter device based on a situation that whether the water flow condition satisfies the pre-defined water supply condition when there exists a requirement on water purification from a user.

### BRIEF DESCRIPTION OF THE DRAWINGS

The accompanying drawings herein are incorporated in and constitute part of this description, illustrate examples in accordance with the present disclosure, and serve to explain principles of the present disclosure together with the description.

FIG. 1 is a schematic structural view of a water purifier in the related art.

FIG. 2 is a schematic structural view of a water purifier according to an example.

FIG. 3 is a schematic structural view of another water purifier according to an example.

FIG. 4 is a flowchart of a controlling method of a water purifier according to an example.

FIG. 5 is a flowchart of a controlling method of another water purifier according to an example.

FIG. 6 is a block diagram of a control device of a water purifier according to an example.

FIG. 7 is a block diagram of a determination circuit in the control device of an example water purifier according to an aspect of the disclosure.

FIG. 8 is a block diagram of a switch circuit in the control device of an example water purifier according to an aspect of the disclosure.

FIG. 9 is a block diagram of a switch circuit in the control device of an example water purifier according to an aspect of the disclosure.

FIG. 10 is a block diagram of a switch circuit in the control device of an example water purifier according to an aspect of the disclosure.

FIG. 11 is a schematic structural view of a device for controlling a water purifier according to an example.

### DETAILED DESCRIPTION

Examples herein will be described in detail, examples of which are illustrated in the accompanying drawings. Unless otherwise indicated, like numerals in different drawings indicate the same or similar elements when the following description relates to the accompanying drawings. The examples described in the following examples do not represent all examples in accordance with the present disclosure. Instead, they are merely examples of devices and methods in accordance with some aspects of the present disclosure detailed in the appended claims.

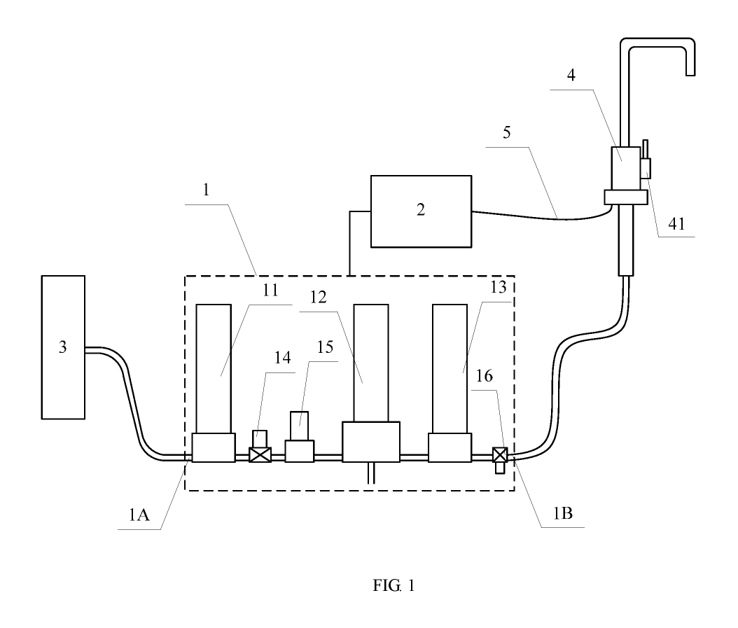

FIG. 1 is a schematic structural view of a water purifier in the related art. As shown in FIG. 1, the water purifier in the related art may include: a filter device 1 and a control device 2; where an input end 1A of the filter device 1 is connected with a water source 3, and an output end 1B is connected with a faucet 4. That is to say, the water purifier uses a ready-to-filter and ready-to-drink structure, and there is no supporting water storage tank to avoid secondary pollution of the water source.

The filter device 1 may take a structure in any form. For example, in the water purifier shown in FIG. 1, the filter device 1 may include a pre-positioned filter element 11, a main filter element 12 and a rear filter element 13 and the like, which are sequentially connected in a pipeline. The filter device 1 may further include an inlet valve 14, a booster pump 15 and an outlet valve 16 (valves such as the inlet valve 14 and the outlet valve 16 may apply any type of valves such as a solenoid valve) and the like in the pipeline of the filter device 1. The inlet valve 14 and the outlet valve 16 are used to control a conducting state or a blocking state of the pipeline so as to control water flow condition in the pipeline, while the booster pump 15 is used to transport water to be purified from the water source 3 to the main filter element 12 and the like in order to filter the water. After being filtered through the pre-positioned filter element 11, the main filter element 12, the rear filter element 13 and the like, the water to be purified may be filtered into purified water and concentrated water, wherein the purified water is supplied to the faucet 4 through the output end 1B, while the concentrated water is discharged through a port (not shown) under the main filter element 12 shown in FIG. 1.

The control device 2 is connected to a control switch (not shown) in the faucet 4 for example by a wire 5. The control switch may send a synchronous control signal to the control device 2 by detecting a switch action of the user to a mechanical valve 41, so that the control device 2 further control the working states of the above-mentioned inlet valve 14, the booster pump 15 and the outlet valve 16, which are electrically connected, so as to start water purification function when the mechanical valve 41 is opened and to stop water purification function when the mechanical valve 41 is closed.

Therefore, based on the water purifier shown in FIG. 1, the start and stop control mode of the water purifier in the related art are controlled according to the intention of user water utilization expressed by the mechanical valve 41 completely. Here, the control device 2 controls the control device 2 controls the inlet valve 14 and the outlet valve 16 to conduct the pipeline and controls the booster pump 15 to start in order to perform water purification operation when the mechanical valve 41 is opened, while the control device 2 controls the inlet valve 14 and the outlet valve 16 to block the pipeline in order to control the booster pump 15 to be stopped when the mechanical valve 41 is closed, so that the water purification operation is completed.

However, the control process mentioned above may operate normally only if the water source 3 can provide a sufficient amount of water to be purified. If the water source 3 is a municipal water pipe and the tap water is stopped or the water pressure is lower, or else if the water source 3 is a structure such as a non-pressure water storage tank, or else if any of filter elements or pipelines in the filter device 1 are blocked (for example caused by congested impurities, different from the blockage caused by closing valves such as the inlet valve 14 and the outlet valve 16) to lead to obstruction of water flow, the amount of water supply of the water source 3 may be lower than water purification requirement of the filter device 1, so that there may exist the following problems:

1. Water in the filter elements such as main filter element 12 may be gradually drained to compensate for insufficient supply of the water to be purified; however, the amount of water in the filter element is limited and thus may not satisfy user requirements. In addition, after the water in the filter element has been completely drained and when the user needs water again, the user still needs to wait various filter elements to be wetted before the filtering function is achieved and the water to be purified is output even after water supply of the water source 3 has returned to a normal state or the flow of water is unobstructed. Therefore, water supply of the water purifier could not match water requirements of the user and user experience could be seriously affected.

2. If the water supply to the water source 3 is insufficient or the water flow inside the filter device 1 is obstructed, the water purifier may not work for a long time, thereby causing damage to the water purifier machine.

Therefore, the present disclosure is intended to solve the technical problems mentioned above in the related art by improving the structure of the water purifier. The technical solutions of the present disclosure will be described combined with the examples in the following.

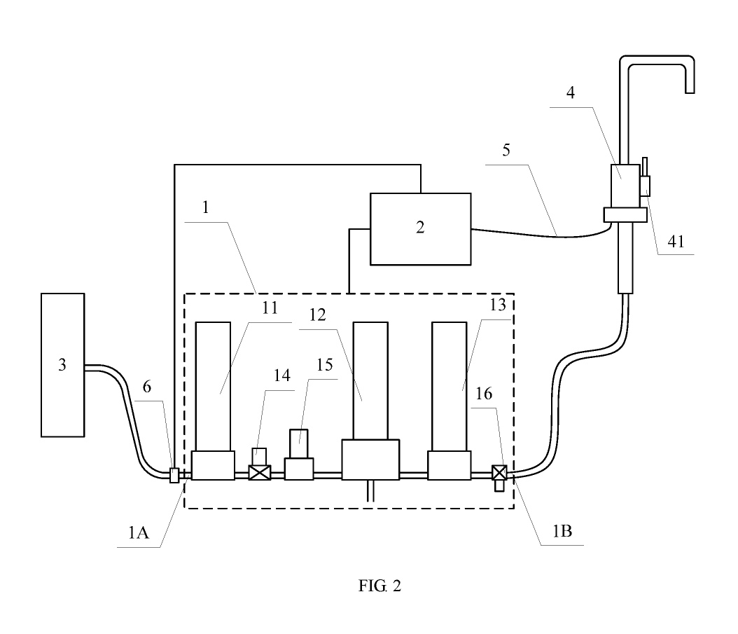

FIG. 2 is a schematic structural view of a water purifier according to an example. As shown in FIG. 2, the water purifier may include: a filter device 1 and a control device 2; wherein an input end 1A of the filter device 1 is connected with a water source 3, and an output end 1B is connected with a faucet 4. The structure of the filter device 1 may refer to the water purifier in the above related art or may refer to other water purifier using a form of ready-to-filter and ready-to-drink in the related art, which will not be described here.

At the same time, the water purifier may further include: a water flow detection device 6 for detecting water flow condition in the filter device 1. When the water source 3 is stopped or water pressure is insufficient, or when a pipeline of the filter device 1 or any of filter elements is blocked, the water flow condition may be “insufficiency of water supply.” When the water supply of the water source 3 is normal and the pipeline of the filter device 1 is unobstructed, the water flow condition may be “normal water supply.”

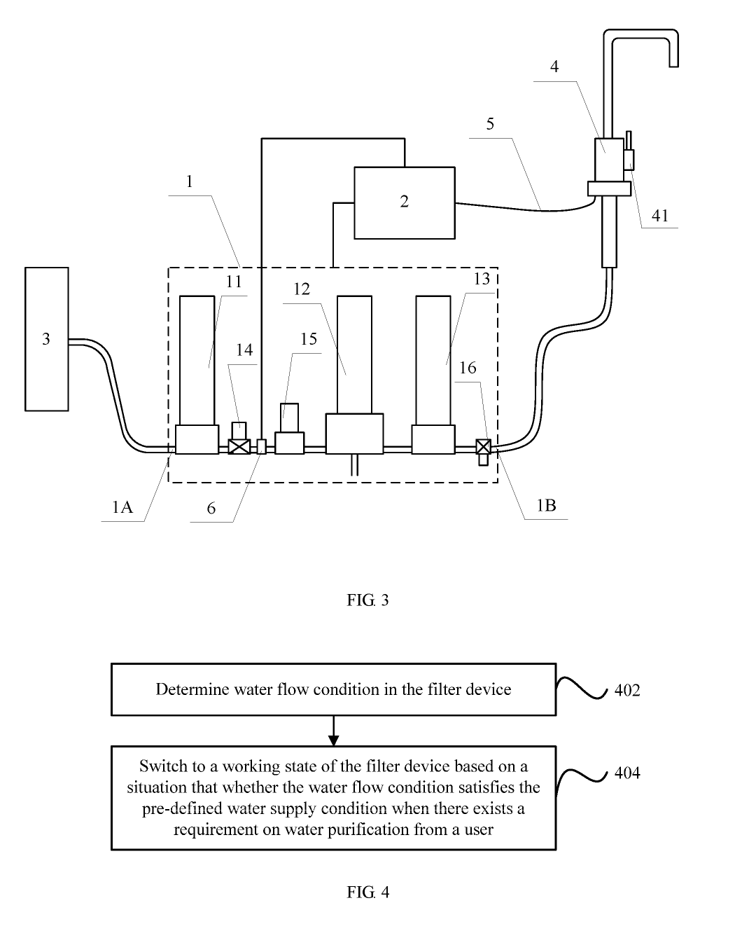

Here, the water flow detection device 6 may be located in any of pipelines in the water purifier. For example, in the example shown in FIG. 2, the water flow detection device 6 may be located in the water inlet pipe between the input end 1A and the water source 3. In the example shown in FIG. 3, the water flow detection device 6 is located in a pipeline between a pre-positioned filter element 11 and a booster pump 15 at a front-end of a main filter element 12, which will not be limited in the present disclosure. Further, in the technical solutions of the present disclosure, a plurality of water flow detection devices 6 may also be respectively disposed in a plurality of pipelines at the same time, thereby realizing a more precise control process.

Thus, the control device 2 may realize a control method of the water purifier shown in FIG. 4 by a power assembly electrically connected to the water flow detection device 6 and the filter device 1 (such as the booster pump 15 and the like), the method may include the following steps.

In step 402, water flow condition in the filter device is determined.

In one example, the control device 2 may obtain the water flow condition by acquiring a detection result output by the water flow detection device 6. Wherein, the water flow detection device 6 may be a water pressure sensor, and the corresponding water flow condition may include water pressure in the pipeline where the water pressure sensor is located. Alternatively or additionally, the water flow detection device 6 may be a water flow sensor, and the corresponding water flow condition may include water flow velocity in the pipeline where the water flow sensor is located. Of course, the water flow detection device 6 may also apply other types of sensors or a combination of multiple sensors (for example, simultaneously apply the water pressure sensor and the water flow sensor, in order to obtain the water pressure and the water flow velocity), which will not be limited by the present disclosure.

In addition, when the control method of the water purifier shown in FIG. 4 is applied to other water purifiers, for example, with respect to the water purifier without containing the water flow detection device 6, the water flow condition in the filter device 1 of the water purifier may be detected by a third-party water flow detection device, so that the control device 2 accordingly performs a control operation such as in step 404.

In step 404, it is switched to a working state of the filter device based on a situation that whether the water flow condition satisfies the pre-defined water supply condition when there exists a requirement on water purification from a user.

In the example, the water supply condition may be used according to the type of parameters included in the water flow condition. For example, when the water flow condition is water pressure, the water supply condition may be such a case that a relationship between pre-defined standard water pressures satisfies a preset numerical relationship, for example, the water pressure is greater than or equal to the standard water pressure. When the water flow condition is water flow velocity, the water supply condition may be such a case that a relationship between pre-defined water flow velocities satisfies a preset numerical relationship, for example, the water flow velocity is greater than or equal to the standard water flow velocity. After that, it can be determined whether the water flow condition satisfies the pre-defined water supply condition by comparing the collected parameter value with the pre-defined standard parameter value.

In one case, when the working state of the filter device 1 in advance is a stop state, the control device 2 may send a first state control instruction to a power assembly such as a booster pump 15 and the like if the water flow condition satisfies the pre-defined first water supply condition, so that the filter device 1 is switched from the stop state to a start state. In the example, the problem of “when to start the water purifier” is solved by analyzing the water flow condition, and the water purifier may only be started if the water supply is sufficient (the water supply for each filter element is sufficient; actually, it may be related to the water supply pressure of the water source 3, and may also be related to the situation whether the filter element or the pipeline in the filter device 1 is unobstructed).

In another case, when the working state of the filter device 1 in advance is a start state, the control device 2 may send a second state control instruction to the power assembly such as the booster pump 15 and the like if the water flow condition does not satisfy the pre-defined first water supply condition, so that the filter device 1 is switched from the start state to a stop state. In the example, the problem of “when to force to stop the water purifier” is solved by analyzing the water flow condition, and the water supply is always sufficient during operation of the water purifier, if not, a forced stoppage may be adopted.

Here, the first water supply condition and the second water supply condition may use any value based on the actual requirements without considering the mutual relationship therebetween (for example, the first water supply condition may be the same as the second water supply condition. Alternatively, the first water supply condition may be stricter than the second water supply condition. For example, during operation of the water purifier, the water supply may have a certain degree of fluctuation due to the unstable water supply pressure of the water source 3, the obstructed water flow inside the filter device 1 and the like. When the fluctuation is small and would not actually seriously affect the water supply, the strictness of the second water supply condition may be appropriately reduced to account for the fluctuation, thereby ensuring continuity of the water supply to the user and facilitating to improve user experience.

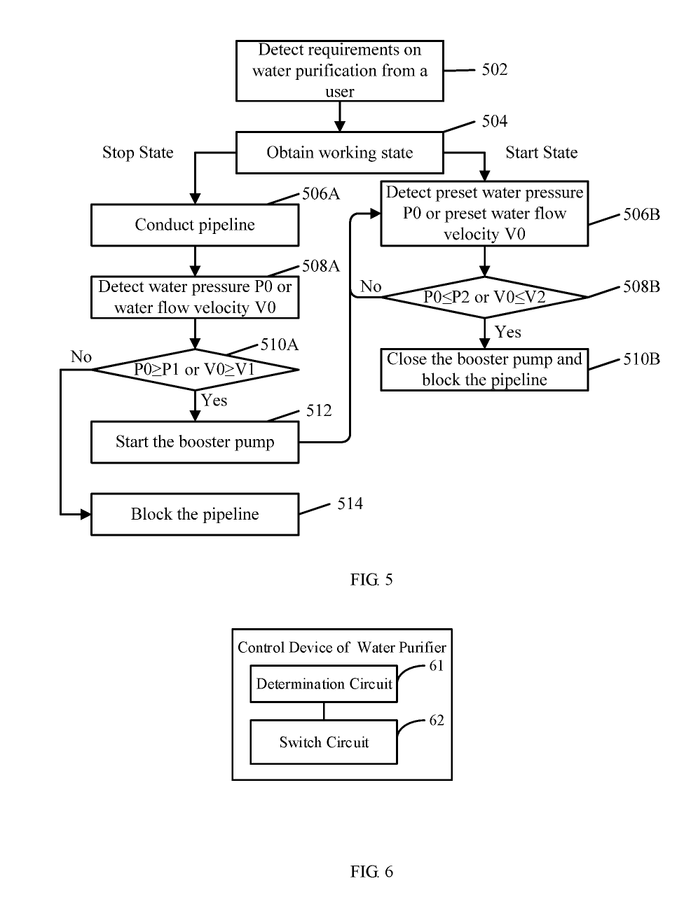

FIG. 5 is a flowchart of a controlling method of another water purifier according to an example. With respect to the water purifier shown in FIG. 2 or FIG. 3, the control method of the water purifier of the present disclosure is described below in combination with FIG. 5. The method is applied to the control device 2 of the water purifier and may include the following steps.

In step 502, a requirement on water purification from a user is detected.

In the example, the control device 2 may be connected to a control switch (not shown) in a faucet 4 by a wire 5 and the like. The control switch may send a synchronous control signal to the control device 2 by detecting a switch action of the user to a mechanical valve 41. Therefore, when a preset synchronous control signal sent by the control switch is received by the control device 2, it can be considered that the user has turned on the mechanical valve 41, so that it is determined that a requirement on water purification from a user is detected.

In step 504, the current working state of the filter device 1 is obtained. When the filter device 1 is in the stop state, the process proceeds to step 506A to implement the start solution of the water purifier below. When the filter device 1 is in the start state, the process forwards to step 506B to implement the forced stoppage solution of the water purifier below.

Start Solution of the Water Purifier

In step 506A, it is controlled to conduct a pipeline in the filter device 1.

In the example, when water flow in the pipeline is controlled by pipeline switches such as an inlet valve 14 and an outlet valve 16 inside the filter device 1 of the water purifier, the control device 2 is electrically connected to these pipeline switches and their switching states are controlled, thereby controlling on-off state of the pipeline in the filter device 1. Thus, when the filter device 1 is still in the stop state, the control device 1 may send a conduction instruction to the corresponding pipeline switch, so that the pipeline in the filter device 1 is conducted, thereby enable the water flow detection device 6 to accurately detect the water flow condition inside the filter device 1.

In step 508A, water pressure P0 or water flow velocity V0 of a preset pipeline is detected.

In the example, the water flow detection device 6 may be a water pressure sensor to detect the water pressure P0. Alternatively, the water flow detection device 6 may be a water flow sensor to detect the water flow velocity V0. Alternatively, the water flow detection device 6 may also include various sensors such as the water pressure sensor and the water flow sensor to simultaneously detect various parameters such as the water pressure P0 and the water flow velocity V0, thereby achieving more accurate detection.

In the example, the water flow detection device 6 may be located in any of pipelines in the water purifier. For example, the water flow detection device 6 may be located in water inlet pipe between the water source 3 and an input end 1A of the filter device 1.

In step 510A, the process forwards to step 512 when the water pressure P0 is greater than or equal to a first preset water pressure P1 or when the water flow velocity V0 is greater than or equal to a first preset water flow velocity V1; and the process forwards to step 514 when the water pressure P0 is not greater than or not equal to the first preset water pressure P1 or when the water flow velocity V0 is not greater than or not equal to the first preset water flow velocity V1.

In the example, when the water flow condition detected by the water flow detection device 6 satisfies the pre-defined first water supply condition, the process proceeds to step 512. When the detected water flow condition does not satisfy the pre-defined first water supply condition, the process turns to step 514. Here, when the water flow condition includes a value of the water pressure being P0, the corresponding first water supply condition may include a relationship between the water pressure P0 and the first preset water pressure P1 satisfying the preset numerical relationship, for example, the water pressure P0 being greater than or equal to first preset water pressure P1. When the water flow condition includes a value of the water flow velocity being V0, the corresponding first water supply condition may include a relationship between the water flow velocity V0 and the first preset water flow velocity V1 satisfying the preset numerical relationship, for example, the water flow velocity V0 being greater than or equal to the first preset water flow velocity V1.

In practice, when P0≥P1 or V0≥V1, it indicates that the water supply normally required may be realized in the pipeline of the filter device 1, so that the water supply of the water source 3 is normal and there is no obstruction in the pipelines and the filter elements inside the filter device 1. When P0 or V0 does not satisfy the above numerical relationship, it indicates that the pipeline in the filter device 1 is obstructed, so that the pressure of the water supply of the water source 3 may be insufficient or there is obstruction in the pipelines and the filter elements inside the filter device 1.

In step 512, the booster pump 15 is started.

In the above example of the start solution of the water purifier, when the water supply is sufficient, the control device 2 sends a first state control instruction to the booster pump 15 to start the booster pump 15, so that the filter device 1 is switched into the start state and the water purifier starts to normally supply water to the user.

Further, after the booster pump 15 is started, the filter device 1 is switched into the start state, and thus it is turned to step 506B to perform the forced stoppage solution of the water purifier mentioned in the following 2).

In step 514, the pipeline is blocked.

In the example, when it is determined that the water flow condition does not satisfy the pre-defined first water supply condition, the water purifier is not allowed to start the water purification function. Therefore, the control device 2 may send a close instruction to the pipeline switches such as the inlet valve 14 and the outlet valve 16, so that the pipeline in the filter device 1 restores to be unobstructed and maintains the stop state of the filter device 1.

Forced Stoppage Solution of the Water Purifier

In step 506B, the preset water pressure P0 or the preset water flow velocity V0 of the pipeline is detected.

In the step 508B, when the water pressure P0 is smaller than or equal to the second preset water pressure P2, or when the water flow velocity V0 is smaller than or equal to the second preset water flow velocity V2, the process forwards to step 510B; when the water pressure P0 is smaller than or equal to the second preset water pressure P2, or when the water flow velocity V0 is smaller than or equal to the second preset water flow velocity V2, the process forwards to step 506B.

In the example, when the water flow detection device 6 detects that the water flow condition satisfies the pre-defined second water supply condition, the process proceeds to step 510B. When the water flow condition does not satisfy the pre-defined second water supply condition, the process turns to step 506B. Here, when the water flow condition includes a value of the water pressure being P0, the corresponding second water supply condition may include a relationship between the water pressure P0 and the second preset water pressure P2 satisfying the preset numerical relationship, for example, the water pressure P0 being smaller than or equal to the second preset water pressure P2; when the water flow condition includes a value of the water flow velocity being V0, the corresponding second water supply condition may include a relationship between the water flow velocity V0 and the second preset water flow velocity V2 satisfying the preset numerical relationship, for example, the water flow velocity V0 being smaller than or equal to the second preset water flow velocity V2.

In practice, when P0 [symbol] P2 or V0 [symbol] V2, it indicates that the water pressure in the pipeline of the filter device 1 is too low or flow of the water is too small, so that the water supply normally required may not be realized. Therefore, the water supply of the water source 3 is abnormal (for example, the tap water is stopped; or non-pressure water sources such as the water storage tank is applied) or there is obstruction in the pipeline or the filter element inside the filter device 1. When P0 or V0 does not satisfy the above numerical relationship, it indicates that the pipeline in the filter device 1 is unobstructed and is not required to be handled.

It should be noted that: the first water supply condition and the second water supply condition may be respectively defined. Alternatively, there may exist a preset relationship between the first water supply condition and the second water supply condition, for example, the first water supply condition may be stricter than the second water supply condition. Taking the parameters as an example, it may be expressed as P1>P2 and V1>V2, the reason of which is that: the water pressure or the water flow velocity may fluctuate due to various factors after the filter device 1 has been started. Although the fluctuation does not affect filter operation of the filter device 1, the water supply of the water purifier may be discontinuous if the same water supply condition is applied, which may go against user experience.

In step 510B, the booster pump 15 is closed and to the pipeline is blocked.

In the above example of the forced stoppage solution of the water purifier, when the working state of the filter device 1 is a start state, on the one hand, the control device 2 is intended to send a second state control instruction to the booster pump 15 to stop the booster pump 15 if it is determined that the water flow condition does not satisfy the pre-defined second water supply condition, and on the other hand, the control device 2 is intended to send a close instruction to pipeline switches such as the inlet valve 14 and the outlet valve 16 to block the pipeline in the filter device 1.

Corresponding to the previous example of the control method of the water purifier, the present disclosure further provides an example of the control device of the water purifier.

FIG. 6 is a block diagram of a control device of a water purifier according to an example. With reference to FIG. 6, an input end of the filter device of the water purifier is connected with a water source, and an output end is connected with a faucet; the device includes a determination circuit 61 and a switch circuit 62. Wherein:

the determination circuit 61 is configured to determine water flow condition in the filter device;

the switch circuit 62 is configured to switch a working state of the filter device based on a situation that whether the water flow condition satisfies the pre-defined water supply condition when there exists a requirement on water purification from a user.

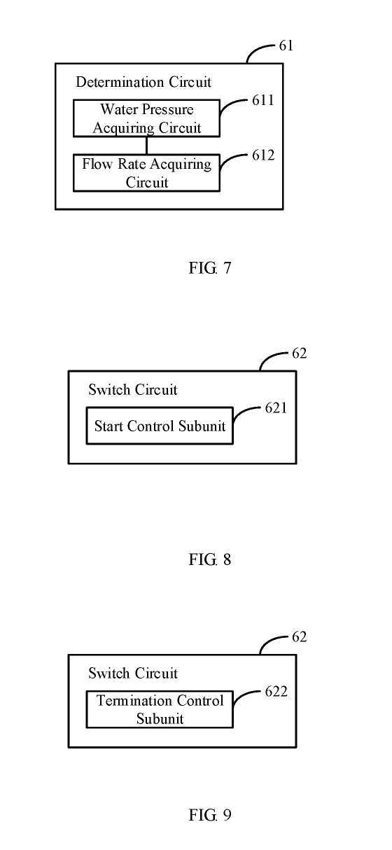

As shown in FIG. 7, FIG. 7 is a block diagram of a control device of another water purifier according to an example. Based on the previous example shown in FIG. 6, the determination circuit 61 may include at least one of: a water pressure acquiring circuit 611 and a flow rate acquiring circuit 612; wherein:

the water pressure acquiring circuit 611 is configured to acquire a water pressure value within a preset pipeline in the water purifier;

the flow rate acquiring circuit 612 is configured to acquire a water flow rate of water to be purified flowing into the water purifier.

As shown in FIG. 8, FIG. 8 is a block diagram of a control device of the other water purifier according to an example. Based on the previous example shown in FIG. 6, the switch circuit 62 may include: a start control subunit 621; wherein:

the start control subunit 621 is configured to send a first state control instruction to a power assembly of the filter device if it is determined that the water flow condition satisfies a pre-defined first water supply condition when the working state of the filter device is a stop state, so that the filter device is switched from the stop state to a start state;

It should be noted that the structure of the start control subunit 621 in the example of the device shown in FIG. 8 may also be included in the example of the device shown in FIG. 7, which will not be limited in the present disclosure.

FIG. 9 is a block diagram of a control device of the other water purifier according to an example. Based on the previous example shown in FIG. 8, the switch circuit 62 may further include: a termination control subunit 622; wherein:

the termination control subunit 622 is configured to send a second state control instruction to the power assembly if it is determined that the water flow condition does not satisfy a pre-defined second water supply condition when the working state of the filter device is the start state, so that the filter device is switched from the start state to the stop state.

Optionally, the first water supply condition is stricter than the second water supply condition.

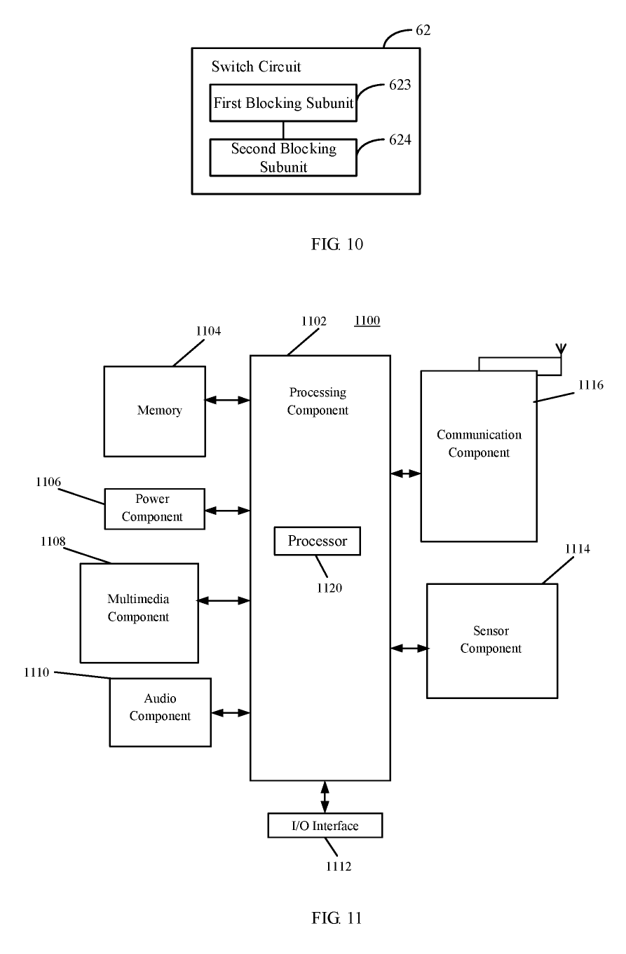

FIG. 10 is a block diagram of a control device of the other water purifier according to an example. Based on the previous example shown in FIG. 6, the switch circuit 62 may include: a first blocking subunit 623 and a second blocking subunit 624; wherein:

the first blocking subunit 623 is configured to conduct the pipeline in the filter device if there exists a requirement on water purification from a user when the working state of the filter device is a stop state, so as to detect the water flow condition; wherein, when it is determined that the water flow condition does not satisfy the pre-defined first water supply condition, the pipeline in the filter device is blocked;

the second blocking subunit 624 is configured to block the pipeline in the filter device if it is determined that the water flow condition does not satisfy a pre-defined second water supply condition when the working state of the filter device is the start state.

Optionally, the first water supply condition is stricter than the second water supply condition.

It should be noted that structures of the first blocking subunit 623 and the second blocking subunit 624 in the example of the device shown in FIG. 10 may also be included in the example of the device shown in FIGS. 7-9, which will not be limited in the present disclosure.

With respect to the device in the above examples, the specific manner in which the respective module performs operation has been described in detail in the example of the method, which will not be explained in detail herein.

For the example of the device, since it basically corresponds to the example of the method, the related description may refer to the description of the example of the method. The example of the device described above is merely illustrative, wherein the units explained as separate components may be or may not be physically separated, and the component displayed as units may be or may not be physical circuit (i.e. it may be located at a place) or may also be distributed over a plurality of network units. Some or all of the modules may be selected to achieve the objectives of the present disclosure according to the actual requirements. Those skilled in the art may understand and implement the present disclosure without any creative work.

Correspondingly, the present disclosure further provide a control device of a water purifier, an input end of a filter device of the water purifier is connected with a water source and an output end is connected with a faucet; the water purifier includes: a processor; a memory for storing processor-executable instructions; wherein the processor is configured to: determine water flow condition in the filter device; switch a working state of the filter device based on a situation that whether the water flow condition satisfies the pre-defined water supply condition when there exists a requirement on water purification from a user.

Correspondingly, the present disclosure further includes a water purifier. The water purifier includes a memory and one or more programs, wherein the one or more programs are stored in the memory and are configured to perform the one or more programs with one or more processors to comprise instructions for the following operations: determining water flow condition in the filter device; switching a working state of the filter device based on a situation that whether the water flow condition satisfies the pre-defined water supply condition when there exists a requirement on water purification from a user.

FIG. 11 is a block diagram of a device 1100 for controlling a water purifier according to an example. For example, the device 1100 may be a water purifier, a water filter and the like.

In FIG. 11, a device 1100 may include one or more of the following components: a processing component 1102, a memory 1104, a power component 1106, a multimedia component 1108, an audio component 1110, an input/output (I/O) interface 1112, a sensor component 1114 and a communication component 1116.

The processing component 1102 typically controls the overall operation of the device 1100, such as operations associated with display, telephone calls, data communication, camera operation and record operation. The processing component 1102 may include one or more processors 1120 to execute instructions, so as to complete all or part of steps of the method mentioned above. In addition, the processing component 1102 may include one or more modules to facilitate interaction between the processing component 1102 and other components. For example, the processing component 1102 may include a multimedia module to facilitate interaction between the multimedia component 1108 and the processing component 1102.

The memory 1104 is configured to store various types of data to support operations of the device 1100. Examples of such data include instructions for any application or method operated on the device 1100, contact data, phone book data, messages, pictures, videos and the like. The memory 1104 may be implemented by any type of volatile or non-volatile storage device or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or an optical disk.

The power component 1106 provides power to various components of device 1100. The power component 1106 can include a power management system, one or more power sources, and other components associated with generating, managing, and distributing power for device 1100.

The multimedia component 1108 includes a screen between the device 1100 and a user that provides an output interface. In some examples, the screen can include a liquid crystal display (LCD) and a touch panel (TP). If the screen includes a touch panel, the screen can be implemented as a touch screen to receive input signals from the user. The touch panel includes one or more touch sensors to sense touches, swipes and gestures on the touch panel. The touch sensor may sense not only the boundary of the touch or sliding action, but also may detect the duration and pressure associated with the touch or sliding operation. In some examples, the multimedia component 1108 includes a front camera and/or a rear camera. When the device 1100 is in an operation mode, such as a shooting mode or a video mode, the front camera and/or the rear camera can receive external multimedia data. Each front and rear camera can be a fixed optical lens system or have focal length and optical zoom capabilities.

The audio component 1110 is configured to output and/or input an audio signal. For example, the audio component 1110 includes a microphone (MIC) that is configured to receive an external audio signal when the device 1100 is in an operational mode, such as a call mode, a recording mode, and a voice recognition mode. The received audio signal may be further stored in the memory 1104 or sent via the communication component 1116. In some examples, the audio component 1110 also includes a speaker for outputting an audio signal.

The I/O interface 1112 provides an interface between the processing component 1102 and a peripheral interface module, which may be a keyboard, a click wheel, a button or the like. These buttons may include, but are not limited to, a home button, a volume button, a start button, and a lock button.

The sensor component 1114 includes one or more sensors for providing a status assessment of various aspects to device 1100. For example, the sensor component 1114 can detect an open/closed state of device 1100, a relative positioning of components such as the display and keypad of device 1100, and the sensor component 1114 can also detect a change in position of one component of the device 1100 or the device 1100. Regardless of the presence or absence of the user contacting with device 1100, orientation or acceleration/deceleration of the device 1100 and temperature of the device 1100 may change. The sensor component 1114 can include a proximity sensor configured to detect the presence of nearby objects without any physical contact. The sensor component 1114 may also include a light sensor, such as a CMOS or CCD image sensor, to use in imaging applications. In some examples, the sensor component 1114 can also include an acceleration sensor, a gyro sensor, a magnetic sensor, a pressure sensor, or a temperature sensor.

The communication component 1116 is configured to facilitate wired or wireless communication between the device 1100 and other devices. The device 1100 can access a wireless network based on a communication standard, such as WiFi, 2G or 3G, or a combination thereof. In an example, the communication component 1116 receives broadcast signals or broadcast associated information from an external broadcast management system via a broadcast channel. In an example, the communication component 1116 also includes a near field communication (NFC) module to facilitate short range communication.

In an example, the device 1100 may be implemented by one or more application specific integrated circuits (ASICs), digital signal processors (DSPs), digital signal processing devices (DSPDs), programmable logic devices (PLDs), field programmable gate arrays (FPGA), controllers, microcontrollers, microprocessors or other electronic components to perform the above method.

In an example, there is also provided a non-transitory computer readable storage medium comprising instructions, such as the memory 1104 including instructions. The above instructions may executed by the processor 1120 of the device 1100 to perform the above method. For example, the non-transitory computer readable storage media may be a ROM, a random access memory (RAM), a CD-ROM, a magnetic tape, a floppy disk, an optical data storage device and the like.

Other examples of the present disclosure will be readily apparent to those skilled in the art in view of the description and practice of the disclosure herein. The present disclosure is intended to cover any variations, uses or adaptations of the present disclosure. Such variations, uses or adaptations changes as the general principles of the present disclosure and include the common general knowledge or the conventional technical means in the art that are not disclosed in the present disclosure. The description and examples thereof are merely considered as exemplary, the true scope and spirit of the present disclosure are pointed out by the following claims.

The technical solution provided by the example of the present disclosure may include the following beneficial effects. The disclosed water purifier may timely adjusts the working state of the filter device of the water purifier, under the situation that the supply of water to be purified is insufficient, by detecting water flow condition of the water source to water to be purified, so as to avoid continuous idling under water shortage and facilitate to extend service life of the water purifier.

It should be understood that both the foregoing general description and the following detailed description are merely exemplary and explanatory, and are not restrictive of the present disclosure.

It should be understood that the present disclosure is not limited to the precise structures described above and shown in the drawings, and various modifications and changes can be made without departing from the scope thereof. The scope of the present disclosure is only limited by the claims.

What is claimed is:

1. A water purifier, comprising:
a filter device, including an input end for water to be purified connected with a source of water to be purified, and an output end for purified water connected with a faucet;
a water flow detection device for detecting water flow condition in the filter device; and
a control device electrically connected to the water flow detection device and a power assembly of the filter device, wherein when there exists a requirement on water purification from a user, the control device sends a corresponding state control instruction to the power assembly based on whether the water flow condition satisfies a pre-defined water supply condition, the state control instruction controls whether to switch a working state of the filter device.

2. The water purifier according to claim 1, wherein the water flow detection device is at least partially disposed in a water inlet pipe between the input end for water to be purified and the source of water to be purified.

3. The water purifier according to claim 1, wherein the water flow detection device comprises at least one of: a water pressure sensor and a water flow sensor.

4. The water purifier according to claim 1, wherein when the working state of the filter device is a stop state, the control device sends a first state control instruction to the power assembly when it is determined that the water flow condition satisfies a pre-defined first water supply condition, so that the filter device is switched from the stop state to a start state.

5. The water purifier according to claim 4, wherein when the working state of the filter device is the start state, the control device sends a second state control instruction to the power assembly when it is determined that the water flow condition does not satisfy a pre-defined second water supply condition, so that the filter device is switched from the start state to the stop state.

6. The water purifier according to claim 1, wherein the control device is further connected to a pipeline switch in the filter device;
when the working state of the filter device is the stop state, the control device sends a conduction instruction to the pipeline switch to conduct a pipeline in the filter device if there exists a requirement on water purification from a user, so that the water flow detection device detects the water flow condition; wherein, when it is determined that the water flow condition does not satisfy the pre-defined first water supply condition, the control device sends a close instruction to the pipeline switch, so that the pipeline in the filter device is blocked; and
when the working state of the filter device is the start state, the control device sends a close instruction to the pipeline switch when it is determined that the water flow condition does not satisfy a pre-defined second water supply condition, so that the pipeline in the filter device is blocked.

7. The water purifier according to claim 5, wherein the first water supply condition is stricter than the second water supply condition.

8. A method for controlling a water purifier comprising a filter device, wherein an input end for water to be purified of the filter device of the water purifier is connected with a source of water to be purified, and in which an output end for purified water is connected with a faucet, the method comprising:
determining water flow condition in the filter device; and
switching a working state of the filter device based on whether the water flow condition satisfies a pre-defined water supply condition when there exists a requirement on water purification from a user.

9. The method according to claim 8, wherein determining water flow condition in the filter device comprises at least of:
acquiring a water pressure value within a preset pipeline in the water purifier and acquiring a water flow rate of water to be purified flowing into the water purifier.

10. The method according to claim 8, wherein switching a working state of the filter device based on whether the water flow condition satisfies a pre-defined water supply condition when there exists a requirement on water purification from a user comprises:
sending a first state control instruction to a power assembly of the filter device when it is determined that the water flow condition satisfies a pre-defined first water supply condition when the working state of the filter device is a stop state, so that the filter device is switched from the stop state to a start state.

11. The method according to claim 10, wherein switching a working state of the filter device based on whether the water flow condition satisfies a pre-defined water supply condition when there exists a requirement on water purification from a user further comprises:
sending a second state control instruction to the power assembly when it is determined that the water flow condition does not satisfy a pre-defined second water supply condition when the working state of the filter device is the start state, so that the filter device is switched from the start state to the stop state.

12. The method according to claim 8, wherein switching a working state of the filter device based on whether the water flow condition satisfies a pre-defined water supply condition when there exists a requirement on water purification from a user comprises:
conducting a pipeline in the filter device to detect the water flow condition if there exists a requirement on water purification from a user when the working state of the filter device is a stop state; wherein, when it is determined that the water flow condition does not satisfy the pre-defined first water supply condition, so that the pipeline in the filter device is blocked; and
blocking the pipeline in the filter device when it is determined that the water flow condition does not satisfy a pre-defined second water supply condition when the working state of the filter device is the start state.

13. The method according to claim 11, wherein the first water supply condition is stricter than the second water supply condition.

14. A control device of a water purifier comprising a filter device, wherein an input end for water to be purified of the filter device of the water purifier is connected with a source of water to be purified, and in which an output end for purified water is connected with a faucet, the device comprising:
a determination circuit configured to determine water flow condition in the filter device; and
a switch circuit configured to switch a working state of the filter device based on whether the water flow condition satisfies a pre-defined water supply condition when there exists a requirement on water purification from a user.

15. The device according to claim 14, wherein the determination circuit comprises at least one of: water pressure acquiring circuit and flow rate acquiring circuit, wherein,
the water pressure acquiring circuit is configured to acquire a water pressure value within a preset pipeline in the water purifier; and
the flow rate acquiring circuit is configured to acquire a water flow rate of water to be purified flowing into the water purifier.

16. The device according to claim 14, wherein the switch circuit is configured to send a first state control instruction to the filter device when it is determined that the water flow condition satisfies a pre-defined first water supply condition when the working state of the filter device is a stop state, so that the filter device is switched from the stop state to a start state.

17. The device according to claim 16, wherein the switch circuit is configured to send a second state control instruction to the power assembly when it is determined that the water flow condition does not satisfy a pre-defined second water supply condition when the working state of the filter device is the start state, so that the filter device is switched from the start state to the stop state.

18. The device according to claim 14, wherein the switch circuit is configured to:
conduct a pipeline in the filter device if there exists a requirement on water purification from a user when the working state of the filter device is a stop state, so as to detect the water flow condition; wherein, when it is determined that the water flow condition does not satisfy the pre-defined first water supply condition, the pipeline in the filter device is blocked; and
block the pipeline in the filter device when it is determined that the water flow condition does not satisfy a pre-defined second water supply condition when the working state of the filter device is the start state.

19. The device according to claim 17, wherein the first water supply condition is stricter than the second water supply condition.
